(19) United States
(12) Patent Application Publication
(10) Pub. No.: US 2024/0140707 A1
(43) Pub. Date: May 2, 2024

(54) Automatic Vending Machine

(71) Applicant: SANDEN RETAIL SYSTEMS CORPORATION, Isesaki-shi, Gunma (JP)

(72) Inventors: Akira MATSUMOTO, Isesaki-shi (JP); Takaaki ARAI, Isesaki-shi, Gunma (JP)

(21) Appl. No.: 18/279,471

(22) PCT Filed: Feb. 1, 2022
(86) PCT No.: PCT/JP2022/003728

§ 371 Date: Aug. 30, 2023

(30) Foreign Application Priority Data
Mar. 3, 2021 (JP) 2021-033346

(51) Int. Cl. B65G 1/06; G07F 11/58

(52) U.S. Cl. CPC B65G 1/06; G07F 11/58; B65G 2203/041

(57) ABSTRACT

To acquire information to accurately determine whether predetermined events related to moving of product have been completed. An automatic vending machine 1 includes: a box-shaped cabinet 4 internally including a plurality of shelves 4f; a product outlet 4d provided at a lower portion of a front panel 4b of the cabinet 4; a product discharging device 5 provided on each of the plurality of shelves 4f in the cabinet and configured to discharge a product P loaded thereon forward; a bucket 6 supported between the front panel 4b and the plurality of shelves 4f so as to be movable in the up-down direction and configured to receive the product P discharged from the product discharging device 5; and an imaging unit 10 that captures an image containing an image of a placement surface 6a on which the product P received is loaded in the bucket 6.

### TECHNICAL FIELD

The present invention relates to an automatic vending machine capable of vending a plurality of products in various shapes and sizes.

### BACKGROUND ART

An automatic vending machine as described in Patent Document 1 has been known for vending products in various shapes and sizes. The automatic vending machine described in Patent Document 1 includes a box-shaped cabinet that internally includes a plurality of shelves spaced apart from each other in an up-down direction, a product outlet provided at the front lower portion in the cabinet, a product discharging device provided on each of the shelves in the cabinet and configured to discharge a product loaded thereon forward, and a bucket supported in front of the shelves and movable in the up-down direction to receive the product discharged from the product discharging device. In this automatic vending machine, the bucket having received a product is moved (transported) by a bucket moving actuator to the product outlet, and accordingly, the user, such as a purchaser of the product, can take out the product received in the bucket from the product outlet.

### REFERENCE DOCUMENT LIST

### Patent Document

Patent Document 1: JP 2020-035323 A

### SUMMARY OF THE INVENTION

### Problem to be Solved by the Invention

In a bucket-moving type automatic vending machine, such as the automatic vending machine disclosed in Patent Document 1 in which the bucket having received the product is moved to the product outlet, it is important when performing succeeding controls, including control for moving the bucket, to ensure that the product is received in the bucket. Thus, it is conceivable, for example, to provide a photoelectric sensor, which has a light emitter and a light receiver facing each other, on the product discharging device side of the bucket and to estimate, by detecting that the product discharged from the product discharging device has passed through between the light emitter and the light receiver, that the product has been received in the bucket.

However, the information acquired through the above-described photoelectric sensor can only be used to estimate completion of the receipt of the product in the bucket. Therefore, in a bucket-moving type automatic vending machine, such information acquired through the above-described photoelectric sensor is not sufficient to accurately determine whether the receipt of the product in the bucket (i.e., moving or discharging the product from the product discharging device to the bucket) has been completed. Accordingly, further improvement is required.

Furthermore, in a bucket-moving type automatic vending machine, when, for example, a standby control, etc., of the automatic vending machine is required after a product in the bucket is taken out from the bucket via the product outlet port, it is important for performing subsequent control to determine whether the take-out of the product from the bucket via the product outlet port has actually been completed. However, such information acquired through the above-described photoelectric sensor, which is disposed on the product discharging device side of the bucket, cannot be relied on to determine whether the take-out of the product from the bucket via the product outlet port has been completed.

The inventors of the present application have focused on, when controlling a bucket-moving type automatic vending machine, that it is important to acquire information for determining whether events related to movements of a product, such as receipt of the product from the product discharging device in the bucket and take-out of product from the bucket via the product outlet port, have been completed.

An object of the present invention is thus to provide an automatic vending machine capable of acquiring information for accurately determining whether predetermined events related to the movements of a product have been completed.

### Means for Solving the Problem

An aspect of the present invention provides an automatic vending machine that includes a box-shaped cabinet, a product outlet, a product discharging device, and a bucket, and moves the bucket having received a product to the product outlet. The box-shaped cabinet internally includes a plurality of shelves spaced apart from each other in an up-down direction. The product outlet is provided at a lower portion of a front panel of the cabinet. The product discharging device is provided on each of the shelves in the cabinet and discharges a product loaded thereon forward. The bucket is supported between the front panel and the shelves so as to be movable in the up-down direction and receives the product discharged from the product discharging device. The automatic vending machine includes an imaging unit that is provided on the bucket and captures an image including a placement surface on which the product received is loaded in the bucket.

### Effects of the Invention

In the above-described automatic vending machine, the imaging unit provided on the bucket captures the image including the placement surface on which the received product is loaded in the bucket. Thus, for example, when the product is properly received in the bucket (in other words, when the product is properly discharged from the product discharging device), the image captured by the imaging unit contains an image of the product received in the bucket. Thus, using the data of the image acquired by the imaging unit (i.e., information), it can be accurately determined whether predetermined events related to the movements of a product, such as receipt of a product in the bucket, have been completed.

Thus, according to an aspect of the present invention, an automatic vending machine capable of acquiring information for accurately determining whether predetermined events related to the movements of a product have been completed can be provided.

### BRIEF DESCRIPTION OF THE DRAWINGS

FIG. 1 is a front view of an automatic vending machine according to an embodiment of the present invention.

FIG. 2 is a schematic longitudinal sectional view for describing the internal structure of the automatic vending machine.

FIG. 3 is a block diagram illustrating a schematic structure of a control system of the automatic vending machine.

FIG. 4 is a perspective view of a bucket of the automatic vending machine viewed from the upper rear oblique.

FIG. 5 is a front view of the bucket.

FIG. 6 is a right side view of the bucket.

FIG. 7 is a partial enlarged side view of the bucket.

FIG. 8 is a partial enlarged perspective view of the bucket.

FIG. 9 is a partial enlarged view of the bucket including an essential portion of a product moving device viewed from the direction A shown in FIG. 8.

FIG. 10 is a flow chart including a first determination performed by a completion determining unit a control unit.

FIG. 11 is a flow chart including a second determination performed by a completion determining unit a control unit.

FIG. 12 is a flow chart including a third determination performed by a completion determining unit a control unit.

FIG. 13 is a flow chart including a fourth determination performed by a completion determining unit a control unit.

### MODE FOR CARRYING OUT THE INVENTION

Hereinafter, an embodiment of the present invention will be described with reference to the accompanying drawings.

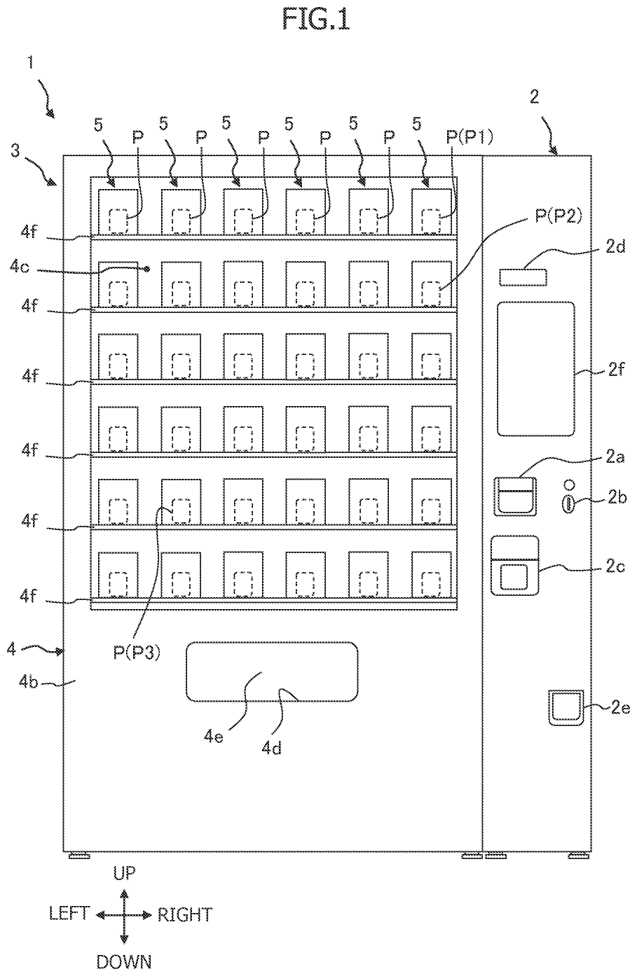

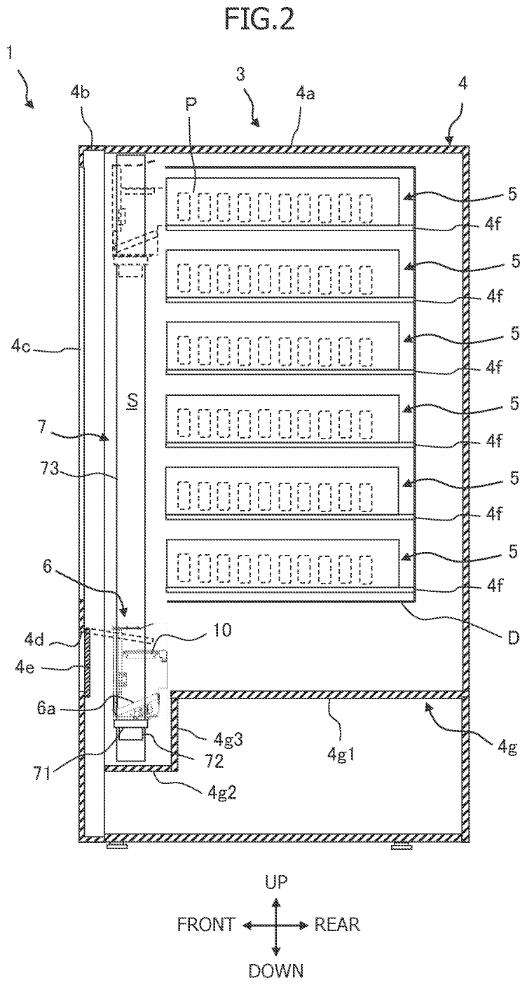

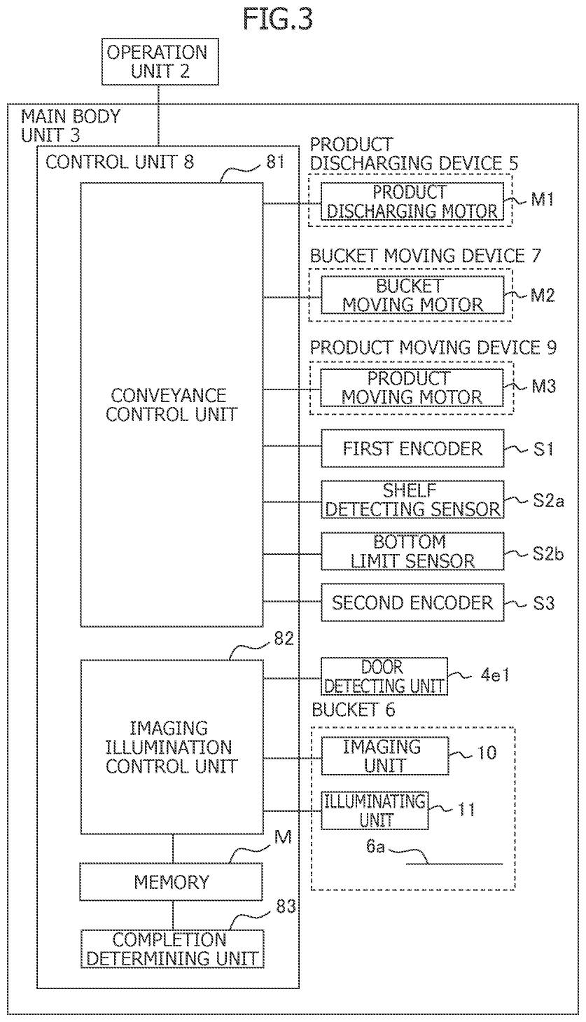

FIG. 1 is a front view of an automatic vending machine 1 according to the present embodiment and FIG. 2 is a schematic longitudinal sectional view for describing an internal structure of the automatic vending machine 1 (specifically, of a main body unit 3, which will be described below). FIG. 3 is a block diagram illustrating a schematic structure of a control system of the automatic vending machine 1. Here, for convenience of explanation, front-rear, left-right, and up-down directions are appropriately shown in the drawings. The left-right direction indicates a direction viewed from a user in front of the automatic vending machine 1 who is facing the front of the automatic vending machine 1. As for the front-rear direction, the user side of the automatic vending machine 1 is indicated as the front side.

As illustrated in FIGS. 1 and 2, the automatic vending machine 1 includes an operation unit 2 operated by the user, etc., and a main body unit 3 storing products P. The automatic vending machine 1 stores a plurality of different products P each packaged in an appropriate bag or container.

The operation unit 2 is formed in a vertically long, box-like shape and is disposed laterally adjacent to the main body unit 3. The operation unit 2 has on its front panel, for example, a bill slot 2a, a coin slot 2b, a non-contact card reader 2c for transaction of electronic money, a money-amount display 2d, a coin return slot 2e, and a touch-panel product selection section 2f. The operation unit 2 is configured to transmit (output) a vending command (vending operation starting command) with respect to a product P selected by the user via the product selection section 2f to the main body unit 3 in response to fee payment by bills, coins, or electronic money.

In the present embodiment, a plurality of products P can be selected at the same time, regardless of their types, via the product selection section 2f in the operation unit 2. When fee payment for the selected plurality of products P is made by the user, the operation unit 2 collectively transmits vending commands for the selected products to the main body unit 3. In this way, the automatic vending machine 1 can perform a billing process capable of dealing with a multiple-item purchase for the products P, so that the user can purchase multiple products P together through a single fee payment operation. The user can also, of course, purchase only a single product P, i.e., transact a single-item purchase by selecting one product P and performing a fee payment operation for the product P.

The main body unit 3 includes a cabinet 4 which is a box-shaped housing, product discharging devices 5, a bucket 6, a bucket moving device 7, and a control unit 8 (see FIG. 3).

The cabinet 4 has a cabinet main body 4a which is open at the front, and a front panel 4b that openably and closably covers the front opening of the cabinet main body 4a. Most of the upper portion of the cabinet main body 4a is formed with a transparent panel 4c, so that the user can view the inside of the main body unit 3 through the transparent panel 4c. A product outlet 4d, through which the user can take out a product P, is provided at a lower portion of the front panel 4b. A rectangular product outlet door 4e opens and closes an opening of the product outlet 4d. The product outlet door 4e is supported at an upper edge portion of the product outlet 4d on a back surface side of the front panel 4b so as to be swingable in the front-rear direction. The product outlet 4d opens when the product outlet door 4e is pushed rearward from the front side.

In addition, in the present embodiment, the cabinet 4 includes a door detecting unit 4e1 (see FIG. 3) that detects opening and closing of the product outlet door 4e. That is, the door detecting unit 4e1 detects whether the product outlet door 4e is in a closing state (closed state) or in an opening state (opened state). The door detecting unit 4e1 is composed of an optical sensor, for example, and is configured to output a detection result to a control unit 8. Although not illustrated, the front panel 4b includes, for example, an electric door lock mechanism that locks and unlocks the product outlet door 4e. When in an initial state (standby state) or during operation of the device, the product outlet door 4e is locked by the door lock mechanism. Thus, for example, tampering with the inside of the device via the product outlet 4d can be prevented

The cabinet 4 internally includes a plurality of (six in the present illustration) shelves 4f vertically spaced apart from each other. Each end in a width direction (left-right direction) of each of the shelves 4f is fixed at a predetermined position in the up-down direction of a corresponding side wall of the cabinet 4. The interior of the cabinet 4 is partitioned by a partition wall 4g into upper and lower areas. Key elements constituting the main body unit 3 are disposed in the upper area. The partition wall 4g includes a below-shelf portion 4g1 that is located behind the front ends of the shelves 4f and below the shelves 4f, a protruding portion 4g2 that protrudes forward relative to the front ends of the shelves 4f and is located below the below-shelf portion 4g1, and a connecting portion 4g3 that connects the front end of the below-shelf portion 4g1 and the rear end of the protruding portion 4g2. The shelves 4f are each disposed closer to the back surface side of the cabinet 4, and a bucket moving space S, in which the bucket 6 moves, is formed between the front ends of the shelves 4f and the front panel 4b, and between the connecting portion 4g3 of the partition wall 4g and the front panel 4b.

In the cabinet 4, an area below the partition wall 4g forms a machine compartment. A duct D is provided inside the cabinet 4 so as to surround the circumference of the shelves 4f. Cold air appropriately circulates through the duct D, thereby cooling the inside of the cabinet 4. Although not illustrated, a cooling unit for generating cold air is provided in the machine compartment and the duct D.

The product discharging devices 5 are each disposed on the corresponding one of the shelves 4 of the cabinet 4 and discharge (dispense) a product P loaded thereon forward. In the present embodiment, each shelf 4f includes a plurality of product discharging devices 5 (six in the present illustration) provided thereon in parallel in a width direction of each shelf 4f.

The product discharging devices 5 each include a discharge mechanism (not illustrated) that discharges a product P forward and a product discharging motor M1 (see FIG. 3) that actuates the discharge mechanism. An appropriate drive system, such as a spiral mechanism, in which a coiled metal rod is rotated, or a belt conveyor mechanism, for example, may be employed as the discharge mechanism.

A plurality of products P is loaded on each product discharging device 5 in a line in the front-rear direction. Each product discharging motor M1 is driven based on a discharging command from the control unit 8 so that the corresponding product discharging device 5 discharges the plurality of products P sequentially from the product P in the front-most row toward the front thereof. The bucket 6 is supported between the front panel 4b and the shelves 4f so as to be movable in the up-down direction and receives the product P discharged from the corresponding product discharging devices 5. The bucket 6 is formed in a substantially rectangular shape elongated in the left-right direction of the automatic vending machine 1 in a plan view seen from the top.

The bucket 6 has a placement surface 6a to load the product P received therein. The structure of the bucket 6 will be described later in detail.

The bucket moving device 7 moves the bucket 6 in the up-down direction in the bucket moving space S and moves (conveys) the bucket 6 having received the product P to the position facing the product outlet 4d.

The bucket moving device 7 has a width in the left-right direction substantially equal to that of each of the shelves 4f and includes a bucket mounting portion 71 on which the bucket 7 is mounted, a support plate 72 that horizontally supports the bucket mounting portion 71, and a lift actuator 73 that moves the support plate 72 in the up-down direction. The lift actuator 73 includes, for example, a pair of upper and lower pulleys (not illustrated), a pulley belt (not illustrated) wound around the pair of upper and lower pulleys, and a bucket moving motor M2 (see FIG. 3) that rotationally drives the pulleys. The end of the support plate 2 is fixed at a predetermined position in a peripheral direction of the pulley belt. The bucket moving device 7 causes the bucket moving motor M2 to rotationally drive the pulleys, thereby moving (lifting or lowering) the bucket 6 in the up-down direction.

In the present embodiment, the bucket moving motor M2 of the bucket moving device 7 is driven based on a bucket moving command from the control unit 8, and the bucket moving device 7 thereby moves the bucket 6 to positions each facing the front end of the corresponding shelf 4f in each level and to a position facing the product outlet 4d. Specifically, at a position at which the bucket 6 faces the front end of the corresponding shelf 4f, the control unit 8 controls driving of the bucket moving motor M2 such that the rear end of the placement surface 6a of the bucket 6 is positioned at the height position slightly below the placement surface of the corresponding product discharging device 5 on which the product P is loaded. In addition, the position at which the bucket 6 faces the product outlet 4d is below the position of the lowermost shelf 4f and corresponds to a standby position of the bucket 6 and a take-out position of product P. The product outlet 4d is located in front of the bucket 6 at the standby position or the take-out position. Accordingly, when the door lock mechanism is driven to be unlocked, the user, etc., can open the product outlet door 4e and insert a hand inside the bucket 6.

In this way, the bucket moving device 7 moves the bucket 6, thereby conveying the product P between each product discharging device 5 and the product outlet 4d. Here, the above-described bucket moving device 7 is merely an example, and various mechanisms with various configurations capable of moving the bucket 6 up and down may be employed.

The control unit 8 includes components, such as a CPU, a I/O (information input/output unit), a ROM, and a RAM and controls operations at least of each product discharging device and the bucket moving device 7. The control unit 8 integrally controls the operations of various devices including the product discharging devices 5 and the bucket moving device 7 based, for example, on a vending command from the operation unit 2. The details of the structure of the control unit 8 will be described later.

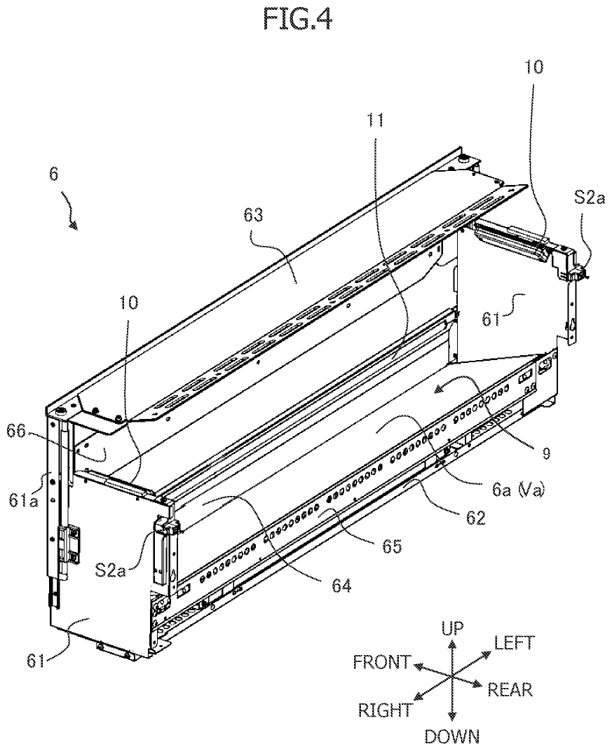

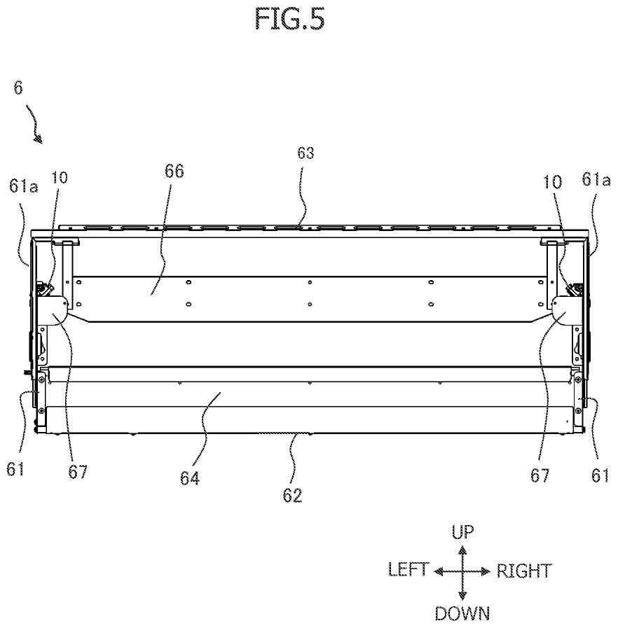

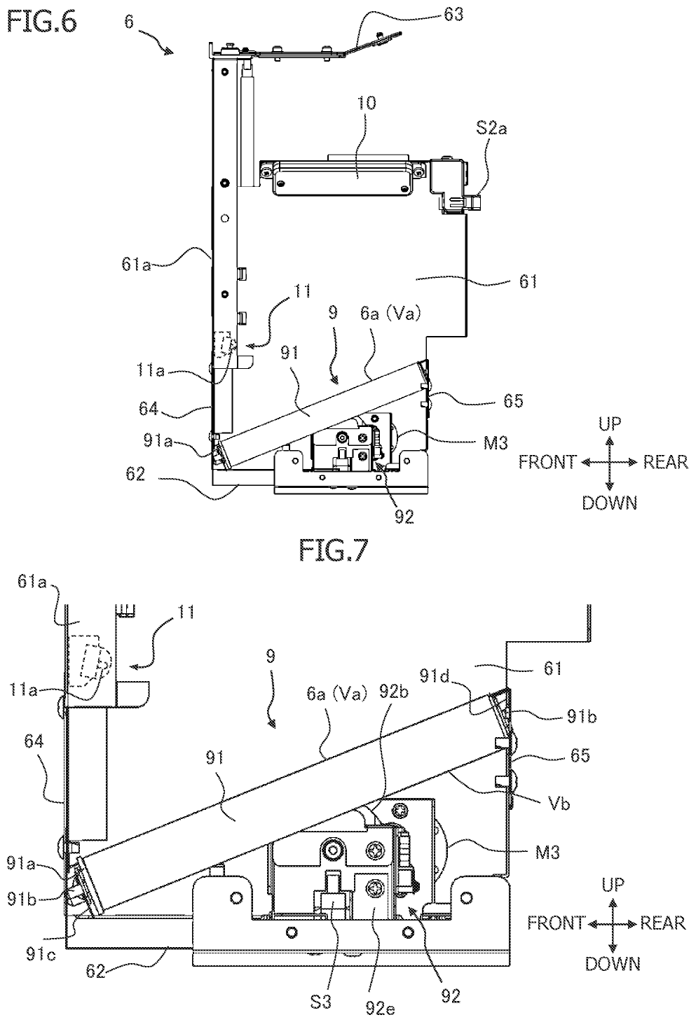

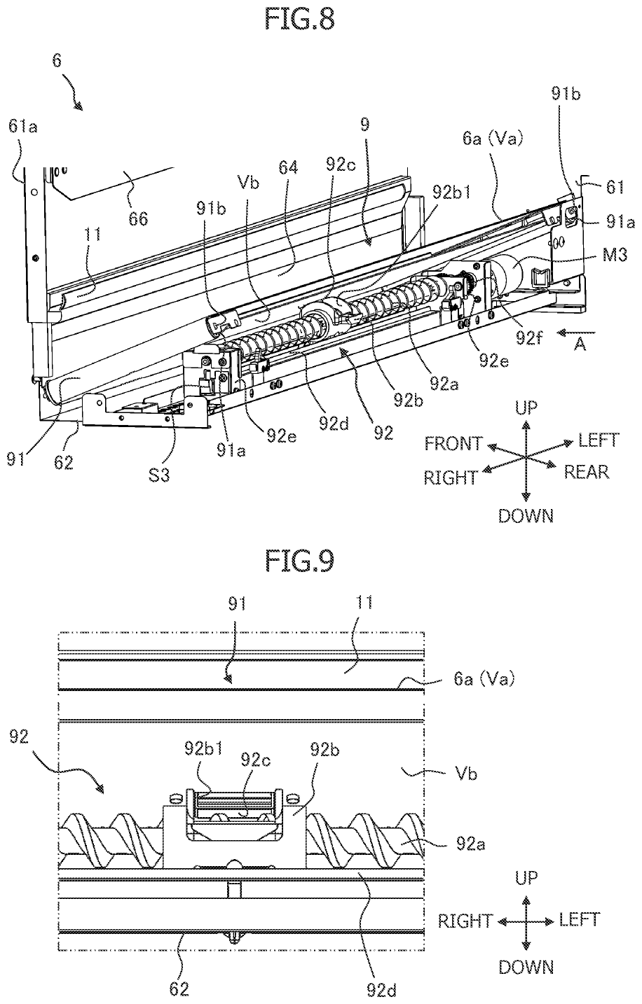

Next, the bucket 6 is described in detail. FIGS. 4 to 8 are drawings illustrating principal parts of the automatic vending machine 1 including the bucket 6. FIG. 4 is a perspective view of the bucket 6 viewed from the upper rear oblique; FIG. 5 is a front view of the bucket 6 viewed from the front; FIG. 6 is a right side view of the bucket 6; FIG. 7 is a partial enlarged side view of the bucket 6; and FIG. 8 is a partial enlarged perspective view of the bucket 6. In FIGS. 6 to 8, a unit including a right-side side panel 61, which will be described below, is removed from the bucket 6 and, in FIG. 8, a rear lower plate 65, which will be described below, is further removed from the bucket 6.

In the present embodiment, the bucket 6 has a width corresponding to the width of each shelf 4 in a plan view seen from the top. Here, the “width corresponding to the width of the shelf” is not limited to the width exactly equal to the width (width in the left-right direction) of each shelf 4, but may slightly differ from the width of each shelf 4. That is, the width of the bucket 6 may be nearly equal to the width of each shelf 4. The placement surface 6a extends over the width direction of the bucket 6 and has a width nearly equal to the width of each shelf 4.

As illustrated in FIGS. 4 and 5, the bucket 6 includes a pair of left and right side plates 61, a bottom plate 62 that connects lower end portions of the left and right side plates 61, a top plate 63 that is supported by the side plates 61 via support column units 61a, front lower plate 64, and a rear lower plate 65.

Each of the side plates 61 is a rectangular plate member that extends in the up-down direction. The bottom plate 62, the top plate 63, the front lower plate 64, and the rear lower plate 65 are each formed in a substantially rectangular shape elongated in the left-right direction, and formed to have a width nearly equal to the width of each shelf 4f. The support column units 61a are each attached to the front end of the corresponding side plate 61 such that the upper portion thereof protrudes upward relative to the upper end portion of the corresponding side plate 61. Opposite ends in the width direction of the top plate 63 are each connected to the upper end of the corresponding support column unit 61a. The front lower plate 64 extends from the front lower end of the left side plate 61 to the front lower end of the right side plate 61 and forms a stopper part for products P. The rear lower plate 65 extends from the rear lower end of the left side plate 61 to the rear lower end of the right side plate 61.

The bucket 6 is formed such that the inside thereof can be accessed from both the front opening and the rear opening. A front plate 66 is provided at the front opening of the bucket 6 so as to be swingable. The front plate 66 is supported by the top plate 63 so as to be swingable about the front end of the top plate 63 in the front-rear direction between the left and right support column units 61a. The front plate 66 is prevented from moving forward than the front surface of the bucket 6 by stopper plates 67 (see FIG. 5) respectively provided at the left and right side plates 61.

In the present embodiment, the bucket 6 includes a product moving device 9 in a form of a belt conveyor that moves the product P in the width direction thereof (of the bucket 6).

As illustrated in FIGS. 6 to 8, the product moving device 9 includes an endless belt 91 wound around a pair of left and right cylindrical pulleys 91a, a belt driving mechanism 92, and a product moving motor M3.

Rotation shafts 91b of respective pulleys 91a each extends in the front-rear direction in a plan view seen from the top and is inclined forwardly downward so as to be closer to the bottom plate 62 toward its front side in a plan view seen from the side. The front end of each pulley 91a is rotatably supported at the lower end of the front lower plate 64 via a front bracket 91c (see FIG. 7). The rear end of the rotation shaft 91b of each pulley 91a is supported at the upper end of the rear lower plate 65 via a rear bracket 91d (see FIG. 7).

As described above, the belt 91 is wound around the pair of left and right pulleys 91 inclined forwardly downward, and accordingly, can run in the width direction of the bucket 6 being inclined forwardly downward. The product P received from the corresponding product discharging device 5 in the bucket 6 is loaded on the upper surface of the belt 91 while sliding down toward the front side along the upper surface of the belt 91, i.e., the upper surface of an upper run Va of the belt 91. Thus, the upper surface of the upper run Va of the belt 91 forms the placement surface 6a on which the product P is loaded in the bucket 6. Here, the upper run Va of the belt 91 corresponds to a section between a portion of the belt 91 that is wound around the upper portion of one of the pulleys 91a and a portion of the belt 91 that is wound around the upper portion of the other one of the pulleys 91a. A lower run Vb of the belt 91 corresponds to a section between a portion of the belt 91 that is wound around the lower portion of one of the pulleys 91a and a portion of the belt 91 that is wound around the lower portion of the other one of the pulleys 91a.

The belt driving mechanism 92 moves (drives) the belt 91 using the product moving motor M3 as a driving force. The mechanism of the belt driving mechanism 92 is not limited to a specific mechanism. In the present embodiment, a mechanism in a form of a linear actuator that converts rotational motion into linear motion is employed. The belt driving mechanism 92 is disposed in a narrow area below the belt 91, specifically, in an area surrounded by the belt 91, the bottom plate 62, and the rear lower plate 65. Thus, the area below the belt 91 formed due to inclination of the belt 91 can be well utilized.

Specifically, as illustrated in FIGS. 6 to 9, the belt driving mechanism 92 in the form of a linear actuator includes a spiral shaft 92a, a mover 92b, a belt engaging portion 92c, and a guide rail 92d. FIG. 9 is a partial enlarged view of a portion including the mover 92b seen from the direction A shown in FIG. 8.

The spiral shaft 92a extends in one direction and has an outer peripheral surface on which a spiral screw portion is formed. The spiral shaft 92a is disposed so as to extend in a running direction (conveying direction) of the belt 91, i.e., in the width direction of the bucket 6. The opposing ends of the spiral shaft 92a are rotatably supported by a pair of left and right shaft supports 92e fixed to the bottom plate 62. The mover 92 internally includes a hemisphere-shaped protrusion that screws with the screw portion of the spiral shaft 92a and engages with the lower run Vb of the belt 91 via the belt engaging portion 92c. The belt engaging portion 92c is fixed to the lower run Vb of the belt 91 and partly protrudes downward from the lower surface of the lower run Vb. The portion of the belt engaging portion 92c protruding downward from the lower surface of the lower run Vb is inserted into a recess 92b1 formed in the mover 92b and sandwiched from both sides in the running direction of the belt 91. The guide rail 92d is provided below the spiral shaft 92a and guides the lower portion of the mover 92b so as to be movable in the extending direction of the spiral shaft 92a (the running direction of the belt 91).

The mover 92b is restricted via the guide rail 92d from rotating about the spiral shaft 92a in a screwed in state with the spiral shaft 92a. As a result, the rotational motion of the spiral shaft 92a is converted into the linear motion in the extending direction of the spiral shaft 92a. Thus, due to the rotation of the spiral shaft 92a, the mover 92b moves in the extending direction of the spiral shaft 92a, and as a result, the lower run Vb of the belt 91 runs (moves) in one width direction of the bucket 6 and the upper run Va of the belt 91 runs (moves) in the opposite direction of the running direction of the lower rung Vb. Here, the belt driving mechanism 92 is not limited to a mechanism in the form of a linear actuator, but may be a pulley-driven mechanism that drives one of the left and right pulleys 91a.

The product moving motor M3 rotationally drives the spiral shaft 92a and is capable of switching the rotational direction between forward and backward directions. The product moving motor M3 is connected to the end of the spiral shaft 92a via, for example, a gear train 92f. The product moving device 9 causes the product moving motor M3 to rotationally drive the spiral shaft 92a so as to cause the upper run Va of the belt 91 to run in the width direction of the bucket 6, thereby moving the product P loaded on the upper surface of the upper run Va (the placement surface 6a) in the width direction of the bucket 6.

The product moving device 9 can move the product P in the bucket 6, selectively in one direction or the opposite direction along the width direction of the bucket 6, by switching the rotational direction of the product moving motor M3. The product moving motor M3 is driven based on a product moving command from the control unit 8 such that the product moving device 9 feeds the upper run Va of the belt 91 in a direction in accordance with the position of the selected product P by a target feed amount (movement amount) in the width direction of the bucket 6.

The automatic vending machine 1 (the main body unit 3) includes an imaging unit 10 and a bucket illuminating unit 11 in addition to the above-described components (4 to 9).

The imaging unit 10 is provided at the bucket 6 and captures an image containing an image of the placement surface 6 on which the product P received in the bucket 6 is placed. The imaging unit 10 is a color camera or monochrome camera that includes, for example, a resin camera case, an imaging element and an imaging circuit unit (not illustrated) stored in the camera case, and an optical system. The imaging element is implemented, for example, by a common device such as a CMOS sensor and a CC sensor. The imaging circuit unit outputs an imaging command to the imaging element based on an imaging command from the control unit 8, and outputs data of the captured image to the control unit 8. The image data output to the control unit 8 is stored (memorized) in a memory M such that the timing of image capturing can be identified Here, in the bucket 6, inner wall surfaces of the pair of left and right side plates 61, the top plate 63, the front lower plate 64, and the rear lower plate 65 are black-colored, and the placement surface 6a (i.e., the belt 91) is green-colored. Thus, the inner surface of the bucket 6 except for the placement surface 6a is black-colored. This can prevent unwanted shadows, which may affect the imaging quality, from being reflected on the placement surface 6a and the product P to be imaged by the imaging unit 10, thereby enabling the placement surface 6a and the product P to be imaged with high imaging quality.

In the present embodiment, one imaging unit 10 is provided on each side in the width direction of the bucket 6. Specifically, each imaging unit 10 is attached to respective upper portions of the pair of left and right side plates 61. In more detail, each imaging unit 10 is attached to the corresponding one of the upper portions of the inner wall portions of the pair of the left and right side plates 61 so as to look down at the placement surface 6a obliquely from above from one side in the width direction of the bucket 6 toward the other side. Each imaging unit 10 can capture an image of substantially the entirety of the placement surface 6a in the width direction of the bucket 6 except for the area directly below each imaging unit 10 itself.

The bucket illuminating unit 11 is provided at the bucket 6 and illuminates the placement surface 6a of the bucket 6. In the present embodiment, the bucket illuminating unit 11 is provided at a predetermined part on the front panel 4b side of the bucket 6 in an orientation directed toward the placement surface 6a. Specifically, the bucket illuminating unit 11 is provided on the upper side of the back surface of the front lower plate 64 of the bucket 6.

In the present embodiment, the bucket illuminating unit 11 includes a plurality of light sources 11a (see FIGS. 6 and 7) disposed in a line across the entire width of the bucket 6. The light sources 11a are each implemented, for example, by a light emitting diode “LED”.

Next, referring back to FIG. 3, the control unit 8 is described in detail.

The control unit 8 includes a conveyance control unit 81, an imaging illumination control unit 82, and a completion determining unit 83, in addition to the memory M.

The conveyance control unit 81 controls the bucket moving motor M2 and the product discharging motor M1 so as to, when a vending command is input for a plurality of products P, each at a different tier (i.e., a plurality of products P each at different positions in the up-down direction), preferentially discharge a product P at an upper tier, and when some of the plurality of products P are at the same tier, preferentially discharge a product P on a predetermined one side of the width direction (e.g., on the right side).

In addition, the conveyance control unit 81 controls the driving of the product moving motor M3 so as to, when a vending command is input for a plurality of products P in the same row (i.e., products P that are at the same position with respect to the width direction of each shelf 4f and at the different position with respect to the up-down direction) or for a plurality of products P that are loaded in the same product discharging device 5, move a preceding product P that is received earlier in the bucket 6 in the width direction of the bucket 6 by a target feed amount (e.g., an amount corresponding to installation interval of the product discharging devices 5 on each shelf 4, or an amount slightly greater than the width of one product P) such that the preceding product P does not interfere (collide) with a succeeding product P to be received in the bucket 6.

Specifically, the conveyance control unit 81 performs (1) a bucket moving control that outputs a bucket moving command to the bucket moving motor M2 of the bucket moving device 7 and drives the bucket moving motor M2 accordingly, (2) a discharge control that outputs a discharging command for each product P to the product discharging motor M1 of the corresponding product discharging device 5 and drives the product discharging motor M1 accordingly, and (3) a product moving control that outputs a product moving command to the product moving motor M3 of the product moving device 9 and drives the product moving motor M3 accordingly.

Regarding the bucket moving control, for example, optical shelf detecting sensors S2a for detecting shelves 4f are each provided at the end of the bucket 6 on the shelves 4 side (in more detail, at the upper portion of the rear end of each side plate 61) (see FIGS. 3, 4, and 6). The shelf detecting sensors S2a each include a light-projecting element for projecting a light beam, and a receiving element. The receiving element receives a reflected light from an object to be detected, and the shelf detecting sensor S2a thereby detects the presence of the object (shelf 4). In addition, the bucket moving device 7 includes a bottom limit sensor S2b (see FIG. 3). The bottom limit sensor S2b detects whether the bucket 6 is in the standby position (i.e., the position facing the product outlet 4d). Signals from the shelf detecting sensors S2a and the bottom limit sensor S2b are input to the control unit 8 (conveyance control unit 81). The control unit 8 outputs, via the conveyance control unit 81, the bucket moving command to the bucket moving motor M2 and drives the bucket moving motor M2 accordingly for each and every operation of: lifting up the bucket 6 from the standby position to the first target shelf 4f corresponding to a vending command; lowering the bucket 6 to the next target shelf 4f; and returning the bucket 6 to the standby position. The conveyance control unit 81 stops the driving of the bucket moving motor M2 when the count of shelf detection since the start of one bucket moving operation based on the bucket moving command reaches the number of shelves to the target shelf 4. The bucket 6 is thereby positioned at the position facing the front end of the target shelf 4f. When the bucket 6 is to be moved to the standby position (the position facing the product outlet 4d), the conveyance control unit 81 stops the driving of the bucket moving motor M2 at the timing when receiving a signal from the bottom limit sensor S2b is input thereto. The bucket 6 is thereby positioned at (returns to) the take-out position (the position facing the product outlet 4d).

Regarding the discharge control, for example, the product discharging devices 5 each includes a first encoder S1 (see FIG. 3) that detects the total number of rotations of the rotary shaft of the product discharging motor M1 during a discharging operation. A signal from the first encoder S1 is input to the control unit 8 (conveyance control unit 81). The control unit 8 outputs, via the conveyance control unit 81, a discharging command for each product P to the product discharging motor M1 of corresponding product discharging device 5 on which the product P corresponding to the vending order from the operation unit 2 is loaded, and drives the product discharging motor M1 accordingly. The conveyance control unit 81 stops the driving of the product discharging motor M1 when the total number of rotations since the start of driving of the product discharging motor M1 reaches the value equivalent to a predetermined feed amount corresponding to one product (e.g., in a case of a spiral-type structure, an amount corresponding to one winding of a spiral metal bar). As a result, all products P move forward by the distance corresponding to one product, and only one product P in the frontmost row is thereby discharged toward the front of the corresponding product discharging device 5.

Regarding the product moving control, the product moving device 9 includes, for example, a second encoder S3 that detects the total number of rotations of the rotary shaft of the product moving motor M3 during a product moving operation. A signal from the second encoder S3 is input to the motor 8 (conveyance control unit 81). As described above, in a case in which a plurality of products P is to be received in the bucket 6 and some of the products P may possibly collide with each other, the conveyance control unit 81 drives the product moving motor M3 in a direction required for avoiding the collision before the corresponding product discharging device 5 starts the discharge operation for the succeeding product P, after the preceding product P is received in the bucket 6. The conveyance control unit 81 stops the driving of the product moving motor M3 when the total number of rotations thereof since the start of driving of the product moving motor M3 reaches a value equivalent to a feed amount required for avoiding collision. The products P loaded on the placement surface 6a thereby moves in the width direction of the bucket 6 by the target feed amount.

In order to capture images at a plurality of predetermined timings in a series of vending operation process of each product P in the main body unit 3, the imaging illumination control unit 82 has a function for controlling the imaging timing of each imaging unit 10 and a function for controlling the light-up timing of the bucket illuminating unit 11.

Specifically, the imaging illumination control unit 82 performs (1) an imaging control that outputs an imaging command to the imaging circuit unit of each imaging unit 10, thereby causing each imaging unit 10 to capture an image at each predetermined timing, (2) a lighting control that outputs a turning-on command to the bucket illuminating unit 11, thereby causing the light source 11a of the bucket illuminating unit 11 to be turned on at least within a predetermined period in which images can be captured by each imaging unit 10.

Regarding the imaging control, the imaging illumination control unit 82 outputs an imaging command to each imaging unit 10 at respective timings before and after a predetermined event among a plurality of events related to the movements of product P. Each imaging unit 10 captures an image of the placement surface 6a and outputs the data of the captured image to the control unit 8 each and every time the imaging command is input from the imaging illumination control unit 82. The outputted image data is stored in the memory M such that the timing of image capturing can be identified. The events related to the movements of product P are events that occur in the automatic vending machine 1 (mainly in the bucket 6).

In addition, when, for example, it is detected based on a signal from the bottom limit sensor S2b that the bucket 6 has returned to the standby position or the take-out position (the position facing the product outlet 4d), the control unit 8 outputs an unlock command to the door lock mechanism accordingly and actuates the door lock mechanism in an unlocking direction. This enables the product outlet door 4e to be opened or closed, thereby allowing the user to take out product P in the bucket 6.

In the present embodiment, the plurality of events related to the movements of product P includes a first event in which the product P is received in the bucket 6, a second event in which the product P is moved in the bucket 6 by the product moving device 9, a third event in which the product P is conveyed via the movement of the bucket 6 caused by the bucket moving device 7, and a fourth event in which the product P is taken out from the bucket 6 via the product outlet 4d. The third event is, more specifically, a conveyance of product P, via the movement of the bucket 6 caused by the bucket moving device 7, to the position facing the product outlet 4d, and is a product conveyance accompanying no movement relative to the bucket 6 while the bucket 6 is moving (is being lowered). In other words, the first event is reception of a product in the bucket 6, the second event is shifting of product for avoiding collision, the third event is conveyance of a product (lowering of product) in a normal attitude without movement relative to the bucket 6, and the fourth event is take-out of product from the bucket 6. The first, second, and fourth events are related to the movements of product P, which is assumed to accompany relative movement between the bucket 6 and the product P and are considered to be normal when accompanying such relative movement. The third event in the present embodiment is related to the movement of a product P moving down together with the bucket 6, which is assumed to accompany no relative movement between the bucket 6 and the product P and is considered to be normal when not accompanying such relative movement.

In the present embodiment, the imaging illumination control unit 82 outputs an imaging command to each imaging unit 10 at each of the timings before and after the first event, before and after the second event, before and after the third event, and before and after the fourth event.

The timings before and after the first event are timings before and after the control unit 8 (conveyance control unit 81) outputs a vending command to the corresponding product discharging device 5. The timings before and after the second event are timings before and after the control unit 8 (conveyance control unit 81) outputs a product moving command to the product moving device 9. The timings before and after the third event are a timing immediately before the control unit 8 (conveyance control unit 81) outputs to the bucket moving device 7 a bucket moving command to the position facing the product outlet 4d, and a timing immediately after the bucket 6 having received a product P is moved by the bucket moving device 7 to the position facing the product outlet 4d. The timings before and after the fourth event are, for example, a predetermined timing after a vending command for the product P is input to the control unit 8 (in the present embodiment, a timing immediately after the bucket illuminating unit 11 is turned on), and a timing after the product outlet door 4e moves from the open to the closed position as a result of opening and closing thereof in a state in which the bucket 6 having received the product P has been moved by the bucket moving device 7 to the position facing the product outlet 4d, and the door detecting unit 4e1 thereby detects that the product outlet door 4e is in a closed state. That is, when the bucket 6 having received the product P is moved by the bucket moving device 7 to the position facing the product outlet 4d, the door lock mechanism is actuated in an unlocking direction. In this state, when the product outlet door 4e is closed again after being opened, for example, by the user, etc., the door detecting unit 4e1 again detects that the product outlet door 4e is in a closed state. The timing after the redetection of this closed state is the latter timing among the aforementioned timings before and after the fourth event.

Regarding the lighting control in the present embodiment, the imaging illumination control unit 82 (the control unit 8) outputs a turning-on command to the bucket illuminating unit 11 (light source 11a) and accordingly turns on the bucket illuminating unit 11 immediately after a vending command for the product P is input, and then, turns off the bucket illuminating unit 11 immediately after the completion determining unit 83 determines that the product P has been taken out from the bucket 6 via the product outlet door 4e (i.e., the fourth event has been completed), as will be described later. That is, in the present embodiment, the placement surface 6a is kept illuminated by the bucket illuminating unit 11 during the period from immediately after a vending operation is started until the vending operation has been completed. After the vending operation has been completed, the bucket illuminating unit 11 is turned off and the automatic vending machine 1 is set to a standby state.

The completion determining unit 83 determines, based on a result of comparison between the data of two images captured by each imaging unit 10 at respective timings before and after a predetermined event among the plurality of events related to the movements of product P that occurs in the automatic vending machine 1, whether the predetermined event has been completed.

The comparison between the data of the two images is performed, for example, by the completion determining unit 83. That is, in the present embodiment, the completion determining unit 83 has a data comparison function and an event completion determination function. The data comparison is performed immediately after the latter image among the two images for comparison is captured. The event completion determination is performed immediately after the data comparison has been completed. In the following description, the completion determining unit 83 has the data comparison function; however, it is not limited to this, and a data comparison unit having a data comparison function may be provided separately.

In the present embodiment, the completion determining unit 83 reads out the data of the two images for comparison from the memory M and performs, for example, a binarization processing (preprocessing) on these data of the read-out images to binarize them into black and white for each pixel. The completion determining unit 83 then calculates a difference value for each pixel between the data of the preprocessed two images as a comparison result. As the difference value is greater, the difference between the two images becomes greater, and as the difference value is smaller, the difference between the two images becomes smaller. That is, in a case in which the events related to the movements of product P, which are considered to be normal when accompanying movement relative to the bucket 6 (in the present embodiment, the first, second, and fourth events), have occurred, the difference value is great, and in a case in which these events have not occurred, the difference value is zero or significantly small. Thus, in relation with each of the first, second, and fourth events, the completion determining unit 83 is configured to determine that, when the calculated difference value for each pixel is greater than a predetermined threshold, the event has been completed, and that, when the calculated difference value for each pixel is smaller than the predetermined threshold, the event has not been completed. Also, in the present embodiment, the third event is related to the movement of a product P, which is considered to be normal when there is no movement relative to the bucket 6 between capturing of one image and capturing of the other image. When the third event has occurred, the difference value is zero or significantly small, and when the third has not occurred (i.e., when the product P is not conveyed in a normal state because the bag containing the product P protrudes out of the bucket 6 and thus gets caught on the front end of the shelf 4f, etc., while the product is lowered, resulting in shifting of the product P within the bucket 6), the difference value is great. Thus, in the present embodiment, in relation with the third event, the completion determining unit 83 is configured to determine that, when the calculated difference value for each pixel is smaller than the predetermined threshold, the third event has been completed, and that, when the calculated difference value for each pixel is greater than the predetermined threshold, the third event has not been completed.

In the present embodiment, the completion determining unit 83 can perform a completion determination for each of all of the first, second, third, and fourth events. When there is a subsequent control to be performed following each event, the control unit 8 can start the subsequent control on the condition that the completion determining unit 83 determines that each event has been completed.

Regarding the first event (reception of product), based on the result of comparison between the data of two images captured by each imaging unit 10 at respective timings before and after the control unit 8 (the conveyance control unit 81) outputs a discharging command to the corresponding product discharging device 5, the completion determining unit 83 performs a first determination that determines whether the first event has been completed. The timing before the discharging command is output to the corresponding product discharging device 5 is, for example, a timing immediately before the control unit 8 outputs the discharging command to the corresponding product discharging device 5. However, for example, in the case of single-item purchase, or in the case of a multiple-item purchase and when the first product is to be received, the timing before the discharging command is output to the corresponding product discharging device 5 in the first determination process is not limited to the above timing and may be, for example, a timing immediately after the operation unit 2 outputs a vending command for a product P to the control unit 8 and the bucket illuminating unit 11 is thereby turned on. At this timing, the bucket 6 is positioned at its standby position in an empty state and the placement surface 6a is being illuminated. Also, in the first determination, the timing after the control unit 8 (the conveyance control unit 81) outputs the discharging command to the corresponding product discharging device 5 is a timing at which it is detected, based on a signal from the first encoder S1, that the total number of rotations of the product discharging motor M1 of the corresponding product discharging device 5 since the start of driving of the product discharging motor M1 reaches a value equivalent to the predetermined feed amount corresponding to one product.

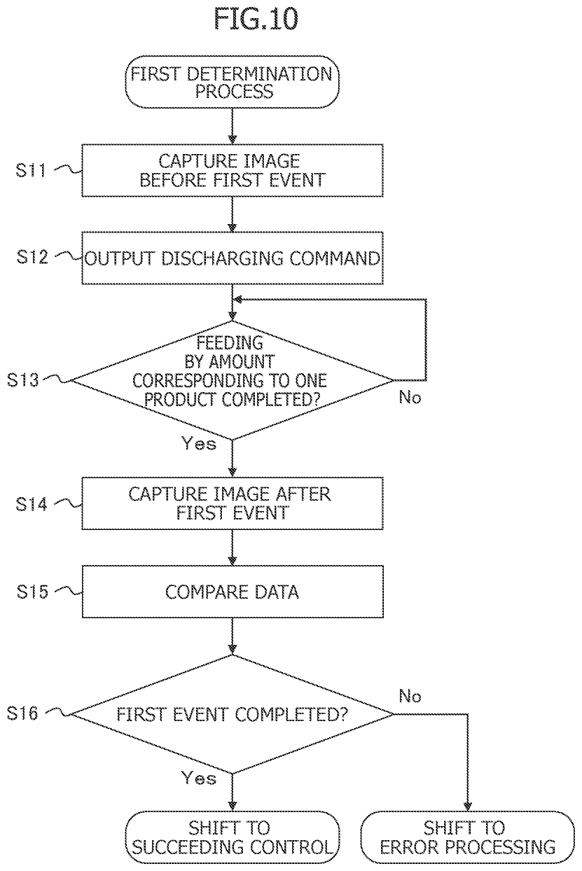

FIG. 10 shows an example of a flow chart including the first determination performed by the completion determining unit 83 at the control unit 8. The control unit 8 outputs an imaging command to each imaging unit 10, for example, at the timing immediately before the discharging command is output to the corresponding product discharging device 5, thereby causing each imaging unit 10 to capture an image before the first event (step S11). The control unit 8 then outputs the discharging command to the corresponding product discharging device 5 (step S12). When it is detected, based on a signal from the first encoder S1, that feeding by the amount corresponding to one product has been completed (step S13: Yes), the control unit 8 outputs an imaging command to each imaging unit 10, thereby causing each imaging unit 10 to capture an image after the first event (step S14). On the other hand, when the feeding by the amount corresponding to one product has not been completed (step S13: No), the control unit 8 does not output any imaging command to each imaging unit 10 and each imaging unit 10 is set to a standby state. Immediately after capturing the image after the first event, the completion determining unit 83 of the control unit 8 performs the data comparison (calculation of the difference value) with respect to the data of the two images before and after the first event (step S15), and based on the comparison result (difference value), determines whether the first event has been completed (step S16). When the difference value is greater than the threshold and the completion determining unit 83 thereby determines that the first event has been completed (step S16: Yes), the control unit 8 shifts to the succeeding control. On the other hand, when the difference value is smaller than the threshold and the completion determining unit 83 thereby determines that the first event has not been completed (step S16: Yes), the control unit 8 shifts to a predetermined error processing.

In the case of a single-item purchase, the succeeding control after the completion of the first event may be the bucket moving control that drives the bucket moving device 7. In the case of a multiple-item purchase, the succeeding control may include the discharge control, the product moving control, and the bucket moving control for discharging, etc., of the next product P, in which the driving of the product discharging device 5, the bucket moving device 7, and the product moving device 9 is controlled as necessary.

Regarding the second event (shifting of product), based on the result of comparison between the data of two images captured by each imaging unit 10 at respective timings before and after the control unit 8 (the conveyance control unit 81) outputs a product moving command to the product moving device 9, the completion determining unit 83 performs a second determination that determines whether the second event has been completed. In the case of a multiple-item purchase and when it is necessary to drive the product moving device 9 to shift the preceding product P for avoiding collision of products, the completion determining unit 83 performs the second determination. The timing before the product moving command is output to the product moving device 9 may be within a period of time until the product moving command is output to the product moving device 9, after it is determined that reception of the preceding product P in the bucket 6 has been completed, and is, for example, a timing immediately before the control unit 8 outputs the product moving command to the product moving device 9. Also, in the second determination, the timing after the control unit 8 (the conveyance control unit 81) outputs the product moving command to the product moving device 9 is, for example, a timing at which it is detected, based on a signal from the second encoder S3, that the total number of rotations of the product moving motor M3 of the product moving device 9 since the start of driving of the product moving motor M3 reaches the predetermined total number of rotations corresponding to a feed amount required for avoiding the collision.

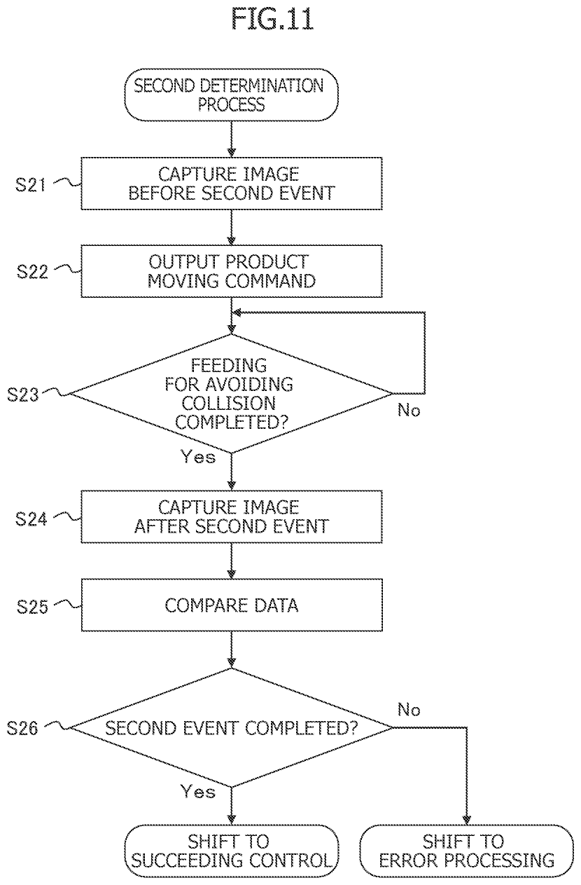

FIG. 11 shows an example of a flow chart including the second determination performed by the completion determining unit 83 at the control unit 8. The control unit 8 outputs an imaging command to each imaging unit 10, for example, at the timing immediately before the product moving command is output to the product moving device 9, thereby causing each imaging unit 10 to capture an image before the second event (step S21). The control unit 8 then outputs the product moving command to the product moving device 9 (step S22). When it is detected, based on a signal from the second encoder S3, that feeding for avoiding collision has been completed (step S23: Yes), the control unit 8 outputs an imaging command to each imaging unit 10, thereby causing each imaging unit 10 to capture an image after the second event (step S24). On the other hand, when the feeding for avoiding collision has not been completed (step S23: No), the control unit 8 does not output any imaging command to each imaging unit 10 and each imaging unit 10 is set to the standby state. Immediately after capturing the image after the second event, the completion determining unit 83 of the control unit 8 performs the data comparison (calculation of the difference value) with respect to the data of the two images before and after the second event (step S25), and based on the comparison result (difference value), determines whether the second event has been completed (step S26). When the difference value is greater than the threshold and the completion determining unit 83 thereby determines that the second event has been completed (step S26: Yes), the control unit 8 shifts to the succeeding control. On the other hand, when the difference value is smaller than the threshold and the completion determining unit 83 thereby determines that the second event has not been completed (step S26: No), the control unit 8 shifts to a predetermined error processing.

When there is no succeeding product P to be received, the succeeding control after the completion of the second event may be the bucket moving control that drives the bucket moving device 7. When there is a succeeding product P to be received, the succeeding control may include the discharge control, the product moving control, and the bucket moving control for discharging, etc., of the next product P, in which the driving of the product discharging device 5, the bucket moving device 7, and the product moving device 9 is controlled as necessary.

Regarding the third event (conveyance of product in normal state without movement relative to the bucket 6) in the present embodiment, based on the result of comparison between the data of two images captured by each imaging unit 10 at respective timings immediately before the control unit 8 (the conveyance control unit 81) outputs to the bucket moving device 7 a bucket moving command to the position facing the product outlet 4d, and immediately after the bucket 6 having received the product P is moved by the bucket moving device 7 to the position facing the product outlet 4d, the completion determining unit 83 performs a third determination that determines whether the third event has been completed. For example, the timing immediately before the bucket moving command to the position facing the product outlet 4d is output to the bucket moving device 7 is, in the case of single-item purchase, a timing immediately after it is determined that reception of the product P in the bucket 6 has been completed, and in the case of a multiple-item purchase, a timing immediately after it is determined that reception of the last product P in the bucket 6 has been completed. Also, the timing immediately after the bucket 6 having received the product P is moved by the bucket moving device 7 to the position facing the product outlet 4d is, for example, a timing at which it is detected, based on a signal from the bottom limit sensor S2b, that the bucket 6 has returned to the standby position or the take-out position.

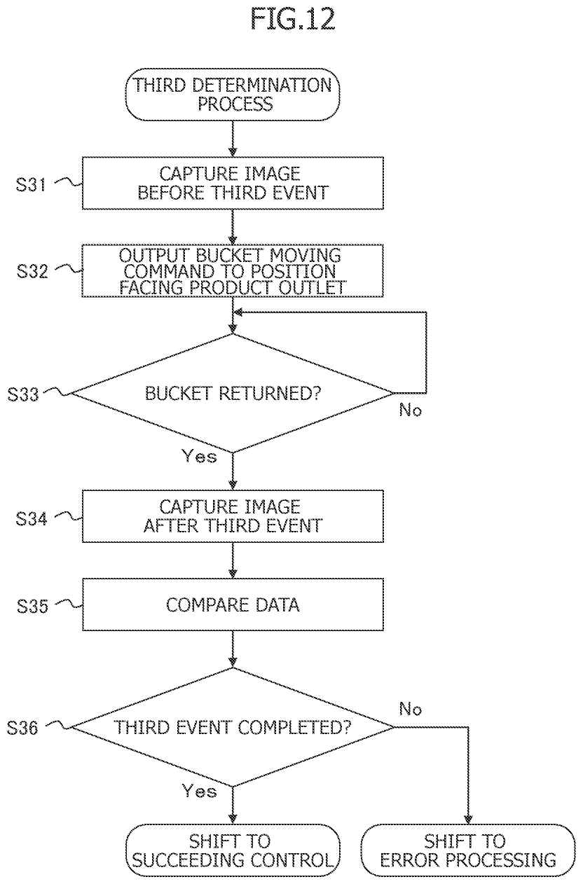

FIG. 12 shows an example of a flow chart including the third determination performed by the completion determining unit 83 at the control unit 8. The control unit 8 outputs an imaging command to each imaging unit 10, for example, at the timing immediately before the bucket moving command to the position facing the product outlet 4d is output to the bucket moving device 7, thereby causing each imaging unit 10 to capture an image before the third event (step S31). The control unit 8 then outputs the bucket moving command to the bucket moving device 7 (step S32). When it is detected, based on a signal from the bottom limit sensor S2b, that the bucket 6 has returned to the standby position or the take-out position (step S33: Yes), the control unit 8 outputs an imaging command to each imaging unit 10, thereby causing each imaging unit 10 to capture an image after the third event (step S34). On the other hand, when the bucket 6 has not returned to the standby position or the take-out position (step S33: No), the control unit 8 does not output any imaging command to each imaging unit and each imaging unit 10 is set to the standby state. Immediately after capturing the image after the third event, the completion determining unit 83 of the control unit 8 performs the data comparison (calculation of the difference value) with respect to the data of the two images before and after the third event (step S35), and based on the comparison result (difference value), determines whether the third event has been completed (step S36). When the difference value is smaller than the threshold and the completion determining unit 83 thereby determines that the third event has been completed (step S36: Yes), the control unit 8 shifts to the succeeding control. On the other hand, when the difference value is greater than the threshold and the completion determining unit 83 thereby determines that the third event has not been completed (step S36: No), the control unit 8 shifts to a predetermined error processing.

The succeeding control after the completion of the third event may include, for example, an imaging process and a calculation process for determination related to the fourth event.

Regarding the fourth event (take-out of product), based on the result of comparison between data of an initial image captured by each imaging unit 10 in a state in which no product P is loaded on the placement surface 6a and an image captured by each imaging unit at the timing after the product outlet door 4e moves from the open to the closed position as a result of opening and closing thereof in a state in which the bucket 6 having received the product P has been moved by the bucket moving device 7 to the position facing the product outlet 4d, and the door detecting unit 4e1 thereby detects that the product outlet door 4e is in a closed state, the completion determining unit 83 performs a fourth determination that determines whether the fourth event has been completed. In the present embodiment, the initial image is an image captured by each imaging unit 10 at the timing immediately after the bucket illuminating unit 11 is turned on. In other words, the initial image is an image captured at the timing immediately after the bucket illuminating unit 11 is turned on, after the vending command for the product P is input to the control unit 8, and is an image in a state in which no product P is loaded on the placement surface 6a and the bucket 6 is thus empty. The timing after the product outlet door 4e moves from the open to the closed position as a result of opening and closing thereof in a state in which the bucket 6 having received product P has been moved by the bucket moving device 7 to the position facing the product outlet 4d, and the door detecting unit 4e1 thereby detects that the product outlet door 4e is in a closed state is, for example, a timing after it is detected, based on a signal from the bottom limit sensor S2b, that the bucket 6 has returned to the standby position and the take-out position and the door detecting unit 4e1 again detects that the product outlet door 4e is in a closed state.

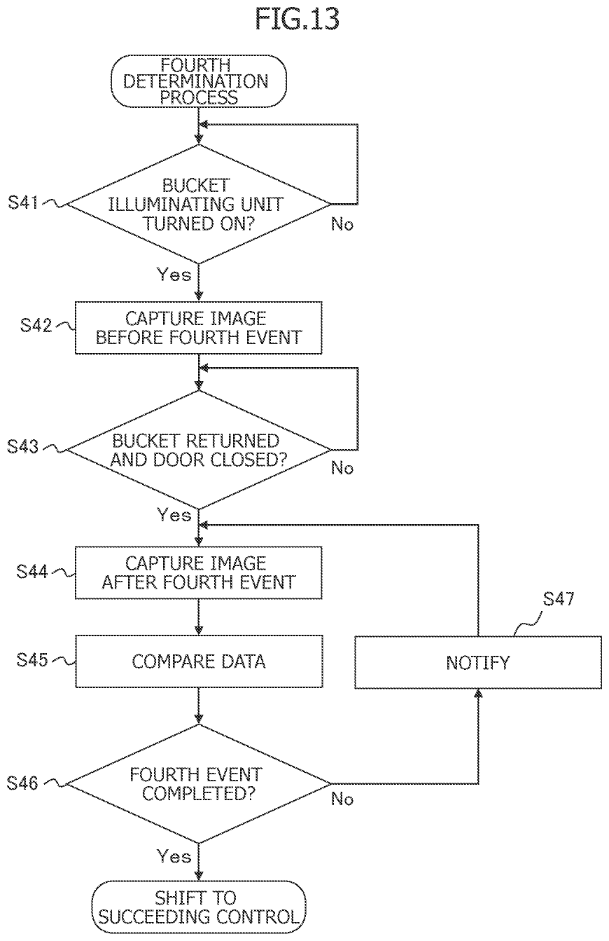

FIG. 13 shows an example of a flow chart including the fourth determination performed by the completion determining unit 83 at the control unit 8. When no vending command is input to the control unit 8 and the bucket illuminating unit 11 is not turned on (step S41: No), the initial image is not captured and the bucket 6 having the imaging unit 10 and the bucket illuminating unit 11 stands by at the standby position. On the other hand, when a vending command is input and the bucket illuminating unit 11 is turned on (step S41: Yes), immediately after that, the control unit 8 outputs an imaging command to each imaging unit 10, thereby causing each imaging unit 10 to capture an image before the fourth event (initial image) (step S42). When it is detected, based on a signal from the bottom limit sensor S2b, that the bucket 6 has returned to the standby position or the take-out position and when the product outlet door 4e moves from the open to the closed position as a result of opening and closing thereof and it is thereby again detected that the product outlet door 4e is in a closed state (step S43: Yes), the control unit 8 outputs an imaging command to each imaging unit 10, thereby causing each imaging unit 10 to capture an image after the fourth event (step S44). On the other hand, when the bucket 6 has not returned to the standby position or the take-out position or when it is not detected that the product outlet door 4e is in a closed state (step S43: No), the control unit 8 does not output any imaging command to each imaging unit 10 and each imaging unit 10 is set to the standby state. Immediately after capturing the image after the fourth event (step S45), the completion determining unit 83 of the control unit 8 performs the data comparison (calculation of the difference value) with respect to the data of the two images before and after the fourth event, and based on the comparison result (difference value), determines whether the fourth event has been completed (step S46). When the difference value is greater than the threshold and the completion determining unit 83 thereby determines that the fourth event has been completed (step S46: Yes), the control unit 8 shifts to the succeeding control. On the other hand, when the difference value is smaller than the threshold and the completion determining unit 83 thereby determines that the fourth event has not been completed (step S46: No), the control unit 8 notifies the user, for example, with sound or display, that the product P has not been taken out (step S47) (the present embodiment includes a case in which some of the products P have not been taken out). In this case (step S46: No), recapturing of image after the fourth event (step S44), data comparison (step S45), and completion determination of the fourth event (step S46) are repeated until it is determined that the fourth event has been completed (in the case of a multiple-item purchase, until it is determined that all products P in the bucket 6 have been taken out) (step S46: Yes).

As described above, when it is detected that the bucket 6 has returned to the standby position or the take-out position, the door lock mechanism is actuated in an unlocking direction. This enables the product outlet door 4e to be opened or closed, thereby allowing the user to take out product P in the bucket 6. When taking out, a multiple-item purchase user may, for example, take out multiple products from the product outlet 4d with a single operation while keeping the product outlet door 4e opened, or may take out the products P in several operations while repeatedly opening and closing the product outlet door 4e. As described above, the image after the fourth event is again captured after the door detecting unit 4e1 detects (again detects) that the product outlet door 4e is in a closed state (step S44). Thus, even in the latter case, the completion of take-out of product P can be determined accurately.

The succeeding control after completion of the fourth event may include, for example, a standby control to set the automatic vending machine 1 in a standby state. For example, when the completion determining unit 83 determines that the fourth event (take-out of product P) has been completed, the control unit 8 causes the imaging illumination control unit 82 to turn off the bucket illuminating unit 11. The automatic vending machine 1 is thereby set to be in the standby state.

The standby control may include not only turning off the bucket illuminating unit 11 but also other controls. For example, in a case, as in the present embodiment, in which the electric door lock mechanism that locks and unlocks the product outlet door 4e is provided, the standby control may include a relocking control of the door lock mechanism. Specifically, when the product P (in the case of a multiple-item purchase, all products P) in the bucket 6 is taken away and the completion determining unit 83 determines that the fourth event has been completed, the control unit 8 outputs a lock command to the door lock mechanism and actuates the door lock mechanism in a locking direction. The automatic vending machine 1 is thereby returned to the standby state in which the product outlet door 4e is locked.

Next, an example of operation of the automatic vending machine 1 is briefly described.

In the description below, as illustrated in FIG. 1, the case in which the user selects as purchase items, via the product selection section 2f of the operation unit 2, a product P (hereinafter, referred to as first product P1) that is loaded on the rightmost product discharging device 5 on the shelf 4f at the top tier (the sixth shelf from the bottom), a product P (hereinafter, referred to as second product P2) that is loaded on the discharging device 5 beneath the first product P1, and a product P (hereinafter, referred to as third product P3) that is loaded on the second product discharging device 5 from the left end on the second shelf 4f from the bottom (i.e., a case of a multiple-item purchase) is exemplified.

This example assumes that (1) an operator, etc., of the automatic vending machine 1 has stocked products P on the product discharging devices 5 in an appropriate orientation without missing stocking (for example, in a case of a spiral type product discharging device 5, each product P in an appropriate size capable of being discharged has been stocked in an appropriate orientation, so as to be able to be discharged onto any loading points each corresponding to one turn of a coiled metal rod), (2) the operator, etc., has correctly entered the number of products loaded (stocked) on each product discharging device 5 via the product selection section 2f and the information input and output section of the control section 8, (3) devices of the automatic vending machine 1 including the product discharging devices 5, the bucket moving device 7, and the product moving device 9 operate normally without malfunction, and (4) none of the bags containing products P protrudes out of the bucket 6 while the products are lowered. That is, the following describes an example of the operation of the automatic vending machine 1 in the case of a multiple-item purchase, in which there are no item stocking t errors of products P (errors including missing items), input errors of information on products P, or device malfunctions.

When fee payment for the three products P selected via the product selection section 2f is made, the operation unit 2 transmits vending commands for these products P to the main body unit 3 (control unit 8). When the vending commands from the operation unit 2 are input to the control unit 8, the control unit 8 turns on the bucket illuminating unit 11 (light source 11a).

The control unit 8 controls the operation of the product discharging devices 5, the bucket moving device 7, and the product moving device 9 so that the products P are received in the bucket 6 in the order of the first product P1, the second product P2, and the third product P3.

The second product P2 is located directly below the first product P1. Thus, if the second product P2 is directly received in the bucket 6 without driving the product moving device 9 after the first product P1 is received in the bucket 6, the second product P2 may be discharged on top of the first product P1 and may damage the first product P1. In this regard, in the present embodiment, for example, the control unit 8 drives the bucket moving device 7 so that the preceding product P (first product P1) is moved to the left by the target feed amount such that the first product P does not interfere with the succeeding product P (second product P2), after the discharge operation of the first product P1 by the corresponding product discharging device 5. As a result, the first product P1 on the placement surface 6a is moved to the left by the target feed amount so as not to interfere with the second product P2. After this occurs, the second product P2 is received in the bucket 6, and thus, the first product P1 can be prevented from being damaged, etc.

After controlling the operation for receiving the third product P3 in the bucket 6, the control unit 8 drives the bucket moving device 7 to move the bucket 6 having received the three products P to the position facing the product outlet 4d (take-out and standby position). In this state, the user can take out the three products P (P1, P2, P3) via the product outlet 4d.

In the above-described example of the operation, it is assumed that there are no problems such as item stocking errors of products P, input errors of information on products P, and device malfunctions. However, there also may be a case in which, even though each device is operating normally, there are item stocking errors or input errors. In such a case, even if each product discharging device 5 has performed a discharge operation of product P normally, it may be that actually an idle operation without involving any product P has been performed. In such a case of idle operation, no product P is actually discharged and no product P is received in the bucket 6 after the discharge operation by each product discharging device 5. That is, after the idle operation, a series of control operations including the subsequent operations performed by the bucket moving device 7 and the product discharging device 5 may be executed as they are without any modification. In this regard, in the present embodiment, the control unit 8 shifts to the subsequent control when the completion determining unit 83 determines that the first event (receipt of product) has been completed (see step S16: Yes, shown in FIG. 10), thereby being prevented from shifting to the subsequent control in an abnormal state.

There also may be a case in which, even though the product moving device 9 is operating normally, depending on the shape of the product P, for example, the product P gets caught on the front lower plate 64 of the bucket 6, etc., and thus is not moved in the width direction of the bucket 6 by the target feed amount. In this regard, in the present embodiment, the control unit 8 shifts to the subsequent control when the completion determining unit 83 determines that the second event (shifting of product) has been completed, thereby being prevented from shifting to the subsequent control in an abnormal state.

In the above-described example of the operation, it is assumed that the bag containing the product P does not protrude out of the bucket 6 while the product is being lowered. However, for example, depending on the size and shape of the bag containing the product P, even if each device is operating normally, the bag of product P may protrude out of the bucket 6 while the product P is lowered together with the bucket 6 toward the position facing the product outlet 4. In such a case, for example, the bag containing the product P may be caught on the front end of the shelf 4f while the product is being lowered, resulting in shifting of the product P within the bucket 6, and furthermore, depending on the degree of the catch, the bag containing the product P may be damaged. The subsequent control operation may come to be performed in such a state. In this regard, in the present embodiment, the control unit 8 moves to the subsequent control when the completion determining unit 83 determines that that the third event (in this embodiment, product conveyance in a normal orientation without relative movement to the bucket 6) has been completed (see step S36: Yes, shown in FIG. 12), thereby being prevented from shifting to the subsequent control in an abnormal state (e.g., a state in which the bag is damaged).

There also may be a case in which, even though each device has operated normally and the bucket 6 having received the product P in response to the vending command has been moved by the bucket moving device 7 to a position facing the product outlet 4d, the product P is not be taken out from the bucket 6 for some reason. When the standby control of the automatic vending machine 1 (e.g., control of the bucket illuminating unit 11 or the door lock mechanism) is required, such standby control cannot be performed unless take-out of product P from the bucket 6 has been completed. In this regard, in the present embodiment, the control unit 8 shifts to the following control when the completion determining unit 83 determines that the fourth event (take-out of product) has been completed (see step S46: Yes, shown in FIG. 13), thereby being prevented from shifting to the subsequent control (standby control) in an abnormal state.

According to the automatic vending machine 1 of the present embodiment, the image containing an image of the placement surface 6a on which a received product P is loaded in the bucket 6 is captured by each imaging unit 10 provided at the bucket 6. Thus, when the product P is properly received in the bucket 6 (in other words, when the product P is properly discharged from the product discharging device 5), the image captured by each imaging unit 10 contains the image of the product P received in the bucket 6. Thus, the data (information) of the image acquired by each imaging unit 10 can be used to accurately determine whether the receipt of the product P in the bucket 6 (first event) has been completed. Similarly, it is also possible to accurately determine whether the second event (shifting of product), third event (conveyance of product), or fourth event (take-out of product) have been completed.

Thus, the automatic vending machine 1 capable of acquiring information to accurately determine whether the predetermined events related to the movements of a product that occurs in the automatic vending machine 1, such as the first, second, third, and fourth events, have been completed can be provided.

According to the automatic vending machine 1 of the present embodiment, the image containing the image of the placement surface 6a on which the received product P is loaded in the bucket 6 is captured by each imaging unit 10 provided at the bucket 6. The completion determining unit 83 of the control unit 8 determines, based on the result of comparison between the data of two images captured by each imaging unit 10 at respective timings before and after a predetermined event among the plurality of events related to the movements of product P, whether the predetermined event has been completed. Thus, the completion determining unit 83 can accurately determine whether the predetermined event has been completed, based on actual images of the inside of the bucket 6 captured at the timings before and after the predetermined event.

Thus, the automatic vending machine 1 capable of accurately determining whether the predetermined events related to the movements of product P have been completed can be provided.

In the case of a multiple-item purchase, for example, there may be a possibility that, in a case in which a smaller succeeding product P is received close to a relatively large product P precedingly received in the bucket 6, a single imaging unit 10 cannot capture an image of the succeeding product P because the succeeding product P is hidden by the preceding product P. In this regard, in the present embodiment, one imaging unit 10 is provided on each side in the width direction of the bucket 6. This enables the imaging unit 10 on either one side to reliably capture the image of the succeeding product P. Accordingly, a blind spot area, in which the succeeding product P is hidden by the preceding product P and cannot be imaged, can be eliminated.

In the present embodiment, the bucket 6 has the width corresponding to the width of each shelf 4. This enables provision of a bucket 6 suitable for a multiple-item purchase in which it is necessary to receive all of a plurality of products P together in the bucket 6.

In the present embodiment, each shelf 4f includes a plurality of product discharging devices 5 (six in the present illustration) provided thereon in parallel in a width direction of each shelf 4f. In addition, the bucket 6 includes the product moving device 9 in the form of a belt conveyor that moves at a product P in the width direction thereof and the upper surface of the upper run Va of the belt 91 of the product moving device 9 forms the placement surface 6. With this configuration, when in the case of a multiple-item purchase, collision between products P can be avoided. This is effective, for example, in a case in which a plurality of products P loaded on the same product discharging device 5, or a plurality of products P each loaded on the corresponding product discharging devices 5 that are disposed at the same position with respect to the width direction of respective shelf 4f, is selected.

In the present embodiment, the bucket illuminating unit 11 that illuminates the placement surface 6a is provided at a predetermined part on the front panel 4b side of the bucket 6 in an orientation directed toward the placement surface 6a. With this configuration, the placement surface 6a, which is within an area to be imaged by the imaging unit 10, can be illuminated without causing the user to feel dazzled, and a clear image can be captured. In addition, the bucket illuminating unit 11 includes the plurality of light sources 11a disposed in a line across the entire width of the bucket 6. With this configuration, the entire placement surface 6a can be illuminated uniformly and a clearer image thus can be captured.

In the present embodiment, the third event is the conveyance of product P to the position facing the product outlet 4d via the movement of the bucket 6 caused by the bucket moving device 7, which accompanies no movement relative to the bucket 6 while the bucket 6 is moving. However, not limited to this, for example, the third event may be merely the conveyance of product P to the position facing the product outlet 4d via the movement of the bucket 6 caused by the bucket moving device 7. In other words, the third event may be an event in which it is assumed that it is to be confirmed that the bucket 6 has reached the position facing the product outlet 4d with the product P being loaded thereon, not merely that the bucket 6 has reached the position facing the product outlet 4d. In such a case, the completion determining unit 83 uses an initial image captured by each imaging unit 10 in a state in which no product P is loaded on the placement surface 6a (specifically, the same image as the initial image used for the determination of completion of the fourth event) as the image before the third event, and based on the result of comparison between the data of this initial image and an image captured by each imaging unit 10 at the timing immediately after the bucket 6 having received the product P is moved by the bucket moving device 7 to the position facing the product outlet 4d, performs a third determination that determines whether the third event has been completed. In this case, the completion determining unit 83 determines in step S36 that, when the difference value is greater than the threshold, the third event has been completed, and when the difference value is smaller than the threshold, the third event has been completed. It thus can be easily confirmed through the determination of completion of the third event that the bucket 6 has reached the position facing the product outlet 4d with the product P being loaded thereon.

In addition, the initial image before the fourth event (including the initial image used as the image before the third event) is the image captured by each imaging unit 10 at the timing immediately after the bucket illuminating unit 11 is turned on. However, not limited to this, an image captured by each imaging unit 10 at the timing immediately after a vending command for the product P is input to the control unit 8 may also be used. In the present embodiment, images captured each and every time a vending command is input is used as the initial image before the fourth event (including the initial image used as the image before the third event). However, not limited to this, for example, images captured in advance at the timing of initial setting in an assembly factory of the automatic vending machine 1 or at the installation site of the automatic vending machine 1 and having stored in the memory M may be used.

In the present embodiment, the operation under the assumption of a multiple-item purchase is exemplified. In a case in which only one product P is selected, (i.e., in the case of a single-item purchase), the automatic vending machine 1 may simply perform a series of vending operation process, including a billing process, a discharge operation by the product discharging device 5, and a moving operation by the bucket moving device 7, for the selected one product P. Furthermore, the automatic vending machine 1 may not be capable of dealing with both a multiple-item purchase and a single-item purchase, but may be capable of dealing with only a single-item purchase. In such a case, the automatic vending machine 1 may simply perform a series of vending operation process, including a billing process, a discharge operation by the product discharging device 5, and a moving operation by the bucket moving device 7, for each selected one product P. In addition, when the automatic vending machine 1 is capable of dealing with only a single-item purchase, a single imaging unit 10 may be provided and the product moving device may not need to be provided.

In the present embodiment, a plurality of product discharge devices 5 is disposed on each shelf 4f in parallel in a width direction of each shelf 4f. However, it is not limited to this, and for example, a single product discharging device 5 may be disposed on each shelf 4f in a line in the up-down direction. In this case as well, such a configuration in which the imaging unit 10 is provided at both sides in the width direction of the bucket 6, the product moving device 9 is provided, and the bucket 6 is formed to have a width corresponding to the width of each shelf 4f is suitable for a multiple-item purchase.

A preferred embodiment of the present invention is described above. However, the present invention is not limited to the above-described embodiment, and clearly, the embodiment may be further modified and changed based on the technical idea of the present invention.

### REFERENCE SYMBOL LIST

1 automatic vending machine
4 cabinet
4b front panel
4d product outlet
4e product outlet door
4e1 door detecting unit
4f shelf
5 product discharging device
6 bucket
6a placement surface
7 bucket moving device
8 control unit
83 completion determining unit
9 product moving device
91 belt
10 imaging unit
11 bucket illuminating unit
11a light source
P product
Va upper run

1. An automatic vending machine comprising:
a box-shaped cabinet internally including a plurality of shelves spaced apart from each other in an up-down direction;
a product outlet provided at a lower portion of a front panel of the cabinet;
a product discharging device provided on each of the plurality of shelves in the cabinet and configured to discharge a product loaded thereon forward; and
a bucket supported between the front panel and the plurality of shelves so as to be movable in the up-down direction and configured to receive the product discharged from the product discharging device,
wherein the automatic vending machine is configured to move the bucket having received the product to the product outlet, and
wherein the automatic vending machine comprises an imaging unit that is provided on the bucket to capture an image including a placement surface on which the product received is loaded in the bucket.

2. The automatic vending machine according to claim 1, wherein one imaging unit is provided on each side in a width direction of the bucket.

3. The automatic vending machine according to claim 2, wherein the bucket has a width corresponding to a width of each of the plurality of shelves.

4. The automatic vending machine according to claim 3, wherein
the plurality of shelves each include a plurality of the product discharging devices provided thereon in parallel in a width direction of each of the plurality of shelves,
the bucket includes a product moving device in a form of a belt conveyor that moves the product in the width direction of the bucket, and
an upper surface of an upper run of a belt of the product moving device forms the placement surface.

5. The automatic vending machine according to claim 1, comprising a bucket illuminating unit provided at a predetermined part on a front panel side of the bucket in an orientation directed toward the placement surface and configured to illuminate the placement surface.

6. The automatic vending machine according to claim 1, wherein the bucket illuminating unit includes a plurality of light sources disposed in a line across an entire width of the bucket.
